(19) United States
(12) Patent Application Publication
(10) Pub. No.: US 2022/0129621 A1
(43) Pub. Date: Apr. 28, 2022

(54) BERT-BASED MACHINE-LEARNING TOOL FOR PREDICTING EMOTIONAL RESPONSE TO TEXT

(71) Applicant: Adobe Inc., San Jose, CA (US)

(72) Inventors: Bhanu Prakash Reddy Guda, Podili (IN); Niyati Chhaya, Telangana (IN); Aparna Garimella, Telangana (IN)

(21) Appl. No.: 17/079,681

(22) Filed: Oct. 26, 2020

(51) Int. Cl. G06F 40/166; G10L 25/63; G06N 20/00; G06K 9/62

(52) U.S. Cl. CPC G06F 40/166; G06K 9/6267; G06N 20/00; G10L 25/63

(57) ABSTRACT

Certain embodiments involve using machine-learning tools that include Bidirectional Encoder Representations from Transformers (“BERT”) language models for predicting emotional responses to text by, for example, target readers having certain demographics. For instance, a machine-learning model includes, at least, a BERT encoder and a classification module that is trained to predict demographically specific emotional responses. The BERT encoder encodes the input text into an input text vector. The classification module generates, from the input text vector and an input demographics vector representing a demographic profile of the reader, an emotional response score.

### TECHNICAL FIELD

This disclosure relates generally to machine-learning systems that facilitate predictions based on user inputs. More specifically, but not by way of limitation, this disclosure relates to using BERT-based machine-learning tools for predicting emotional responses to text.

### BACKGROUND

Neural networks or other machine learning algorithms are often used in software tools for editing or analyzing text. For instance, a software tool could apply a machine-learning model to a set of input text and thereby determine a predicted sentiment or affect associated with the text, such as whether the author of the text intended the text to be critical or laudatory. Such artificial intelligence techniques for processing text are useful in a variety of content editing tools. As an example, these artificial intelligence techniques could be used in online word processing software to suggest changes to improve the readability of certain text content.

Existing solutions have limited capability to predict emotional responses invoked in readers. For instance, existing solutions involve using an empathy lexicon, which is generated by obtaining word ratings and document-level ratings of empathy in a text corpus, to build predictive models for empathy sentiments present in the text of a document. But these existing solutions are frequently focused on the sentiment of the author, which provides limited utility in determining how readers might react to the text. Furthermore, machine-learning techniques used to build such predictive models often fail to account for variations in language preferences based on demographics (e.g., age, education level, etc.). Differences in language preferences among different demographics could alter how certain word choices or writing styles convey a certain emotion or sentiment. Thus, a machine-learning model could fail to accurately predict sentiments such as empathy or distress in a set of text.

### SUMMARY

Certain embodiments involve using machine-learning tools that include Bidirectional Encoder Representations from Transformers (“BERT”) language models for predicting emotional responses to text by, for example, target readers having certain demographics. For instance, a machine-learning model includes, at least, a BERT encoder and a classification module that is trained to predict demographically specific emotional responses. The BERT encoder encodes the input text into an input text vector. The classification module generates, from the input text vector and an input demographics vector representing a demographic profile of the reader, an emotional response score.

Some embodiments involve training such a machine-learning model. For instance, the training process involves using first input text, which has a first value of a demographic attribute for one or more authors of the first input text, and second input text, which has a second value of the demographic attribute for one or more authors of the second input text. The training process involves performing first iterations that modify parameters of the BERT encoder based on the first input text, second iterations that modify parameters of the BERT encoder based on the second input text, and third iterations that modify parameters of the classification module based on training input text vectors and training input demographics vectors. The machine-learning model is outputted with a first parameter value set for the BERT encoder and a second parameter value set for the classification module that are computed with the training process.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which a machine-learning tool based on a bidirectional encoder representations from transformers (“BERT”) model incorporates demographic profile data to compute a predicted emotional response to input text, according to certain embodiments described in the present disclosure.

FIG. 2 depicts an example of a process for using BERT-based machine-learning tools for predicting emotional responses to text, according to certain embodiments described in the present disclosure.

FIG. 3 depicts an example of a BERT-based response prediction model used in the process of FIG. 2, according to certain embodiments described in the present disclosure.

FIG. 4 depicts an example of an architecture for implementing the BERT-based response prediction model of FIG. 3, according to certain embodiments described in the present disclosure.

FIG. 5 depicts an example of a process for training a BERT-based response prediction model to generate emotional response scores, according to certain embodiments described in the present disclosure.

FIG. 6 depicts an example of a user interface generated by a text processing system that uses a BERT-based response prediction model, according to certain embodiments described in the present disclosure.

FIG. 7 depicts another example of a user interface generated by a text processing system that uses a BERT-based response prediction model, according to certain embodiments described in the present disclosure.

FIG. 8 depicts another example of a user interface generated by a text processing system that uses a BERT-based response prediction model, according to certain embodiments described in the present disclosure.

FIG. 9 depicts an example of a BERT encoder to implement certain embodiments depicted in FIGS. 3 and 4, according to certain embodiments described in the present disclosure.

FIG. 10 depicts an example of an encoder layer that could be used to implement the BERT encoder depicted in FIG. 9, according to certain embodiments described in the present disclosure.

FIG. 11 depicts an example of a multi-head self-attention network that can be used in the encoder layer of FIG. 10, according to certain embodiments described in the present disclosure.

FIG. 12 depicts an example of a scaled dot-product attention block that can be used in the multi-head self-attention network of FIG. 11, according to certain embodiments described in the present disclosure.

FIG. 13 depicts an example of a computing system for implementing certain embodiments described in the present disclosure.

FIG. 14 depicts an example of experimental results generated using certain embodiments described in the present disclosure.

FIG. 15 depicts an example of experimental results generated using certain embodiments described in the present disclosure.

FIG. 16 depicts an example of experimental results generated using certain embodiments described in the present disclosure.

FIG. 17 depicts an example of experimental results generated using certain embodiments described in the present disclosure.

### DETAILED DESCRIPTION

Certain embodiments involve using machine-learning tools that include Bidirectional Encoder Representations from Transformers (“BERT”) language models for predicting emotional responses to text by, for example, target readers having certain demographics. For instance, a response prediction engine executed by a computing system includes a BERT-based response prediction model that is trained to predict an emotional response, such as distress or empathy, that will be invoked in a reader by a certain text and customizes this prediction to the reader's demographics (e.g., education, income level, etc.). To do so, the response prediction engine encodes input text with a BERT encoder that, in pre-training phase, has learned to account for demographics of an author when encoding different sets of input text. The response prediction engine combines the encoded input text with an encoded version of input demographic data for the reader. To compute a predicted emotional response from the combined input, the response prediction engine applies an output layer set that has been configured, in a fine-tuning phase, to compute an emotional response score from the combined input (i.e., text and reader demographics). The emotional response score allows, for example, a text editing tool to be used to modify the text to invoke the desired emotional response in a reader.

The following non-limiting example is provided to introduce certain embodiments. In this example, a text-editing tool includes or can access a BERT-based response prediction model for predicting emotional responses to text. The text-editing tool provides an editing interface having a field for inputting text and one or more selection elements for inputting demographics of a potential reader. The text-editing tool receives a set of input text via the field (e.g., a sentence stating, “This technology is crucial to the success of my career.”). The text-editing tool also receives, via the selection elements of the editing interface, input specifying a demographic profile of a potential reader. A demographic profile could be, for example, a set of one or more attributes identifying demographics of a potential reader (e.g., a reader having an educational level of a Bachelor's degree in engineering or science, employment with a government office, and an annual income between $50,000 and $80,000).

Continuing with this example, the text-editing tool provides the input text to a machine-learning model having a BERT encoder and a classification module that is trained to predict demographically specific emotional responses. The BERT encoder generates an input text vector that is an encoded version of the input text. The classification module receives the input text vector and an input demographics vector. In some embodiments, the machine-learning model includes a demographic module having one or more neural networks that encode the demographic profile, which is specified via the input editing interface in this example, into the input demographics vector. The classification module includes one or more classification heads that compute one or more emotional response scores indicating a predicted emotional response induced by the input text in a reader having the demographic profile (e.g., scores representing levels of distress, empathy, etc.). An example of a classification head is a set of one or more dense layers for receiving an encoded input (e.g., a concatenated version of the input text vector and the input demographics vector) followed by a softmax layer that converts an output of the dense layers into the emotional response score.

The text-editing tool uses the classification module to compute one or more emotional response scores. Examples of emotional response scores include a level of distress or empathy that may be invoked in a reader having the demographic profile. In this example, the emotional response score, which is displayed in the editing interface near the inputted text, allows a user to assess how such a reader will react to the text. The user can modify the text to increase or decrease the emotional response score, thereby customizing the text to a particular audience based on predictions from the BERT-based response prediction model.

As described herein, certain embodiments provide improvements to software tools that use machine-learning models for processing text. For instance, existing software tools that might simply determine the author's sentiment for a set of text would be ineffective for customizing text based on the response invoked in a reader, especially with respect to the reader's empathy, distress, or other emotional response. Additionally or alternatively, existing machine learning techniques often fail to account for demographically-based variations in language preferences, which result in those tools being ineffective at predicting how certain aspects of text (e.g., style, word choice, etc.) will impact a reader's empathy, distress, or other emotional response. Relying on these existing technologies could decrease the utility of editing tools that are used for creating content customized to certain readers. Embodiments described herein can facilitate an automated process for creating text that avoids this reliance on ineffective machine-learning models or subjective predictions of a reader's response by an author. For instance, the use of a BERT-based machine-learning model that incorporates demographic profiles into its predictions improves the functionality of a text-editing tool or other text-processing tool. These features allow various embodiments herein to accurately predict emotional responses, thereby reducing the manual, subjective effort involved with customizing text content to certain demographics more effectively than existing software tools.

Examples of BERT-based machine-learning model for computing a predicted emotional response from input text

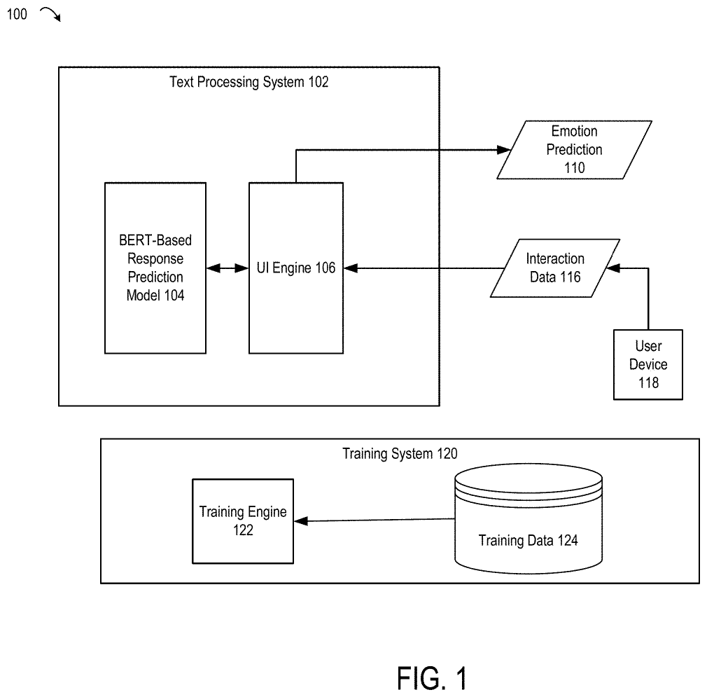

Referring now to the drawings, FIG. 1 depicts an example of a computing environment 100 in which a BERT-based machine-learning tool incorporates demographic profile data to compute a predicted emotional response to input text. FIG. 1 depicts an example of a computing environment 100 for predicting empathy and distress in text data, according to certain embodiments described in the present disclosure. In various embodiments, the computing environment 100 includes one or more of a text processing system 102 and a training system 120.

The text processing system 102 includes one or more computing devices that execute program code providing a text-processing software tool, such as a stand-alone text editor or a text editor incorporated into another application. The text processing system 102, as illustrated in FIG. 1, includes a BERT-based response prediction model 104 and a user interface engine 106.

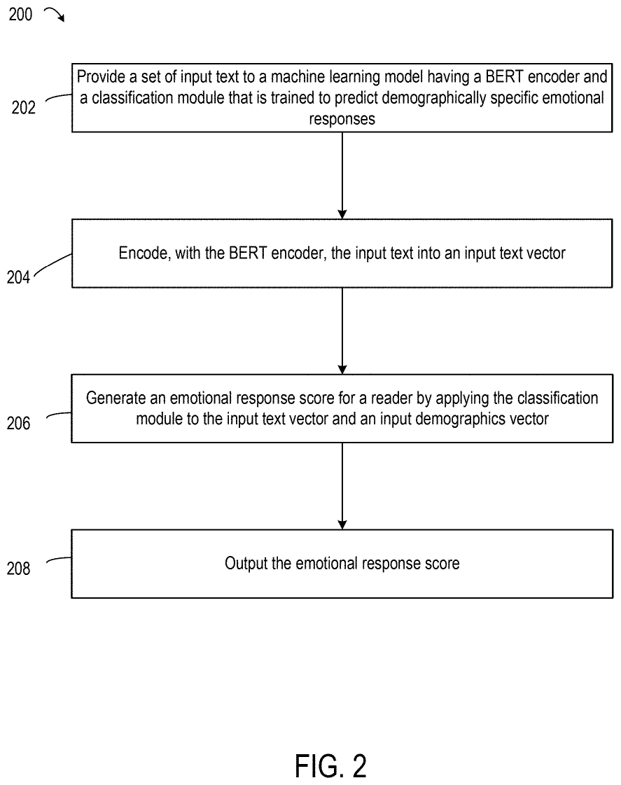

The text processing system 102 applies the BERT-based response prediction model 104 to demographic profile data and a set of input text and thereby computes a predicted emotional response to input text. In some embodiments, the text processing system 102 receives, as an input, interaction data 116 from a user device 118 and outputs an emotion prediction 110, such as an emotional response score. The emotion prediction 110 represents an estimated emotional response to the input text by a reader based on demographic information of the reader. Examples of the emotion prediction 110 include an empathy response and a distress response. In some embodiments, the text processing system 102 outputs a demography prediction with the emotion prediction 110. Examples of computing these predictions are provided herein with respect to FIGS. 2-4.

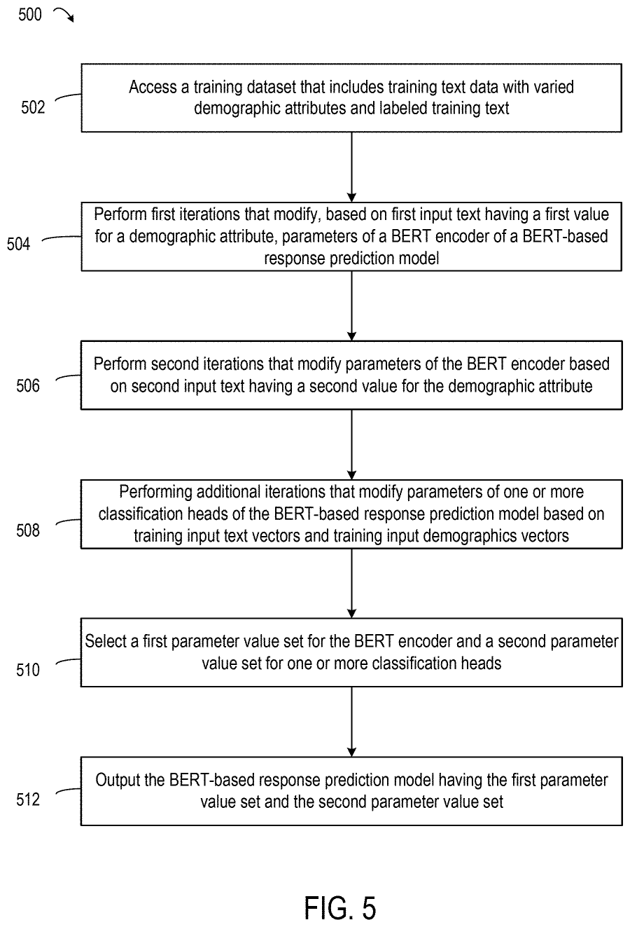

In certain embodiments, the BERT-based response prediction model 104 is a trained neural network or a set of trained neural networks. In these embodiments, the training system 120 facilitates training of the text processing system 102. As illustrated in FIG. 1, the training system 120 includes a training engine 122 and training data 124. In some embodiments, the training engine 122 takes the training data 124 as an input and outputs a trained model relating to the training data 124. For example, the training data 124 includes text inputs, demographic inputs, and ground truth inputs indicating how readers of the text inputs reacted emotionally to the text inputs. This training data 124 is input into the training engine 122, and the training engine 122 trains a model that involves mapping the text inputs and the demographic inputs to emotional reactions such as the empathy response and the distress response. The training system 120 provides the trained model to the text processing system 102. Examples of training the BERT-based response prediction model 104 are described herein with respect to FIG. 5.

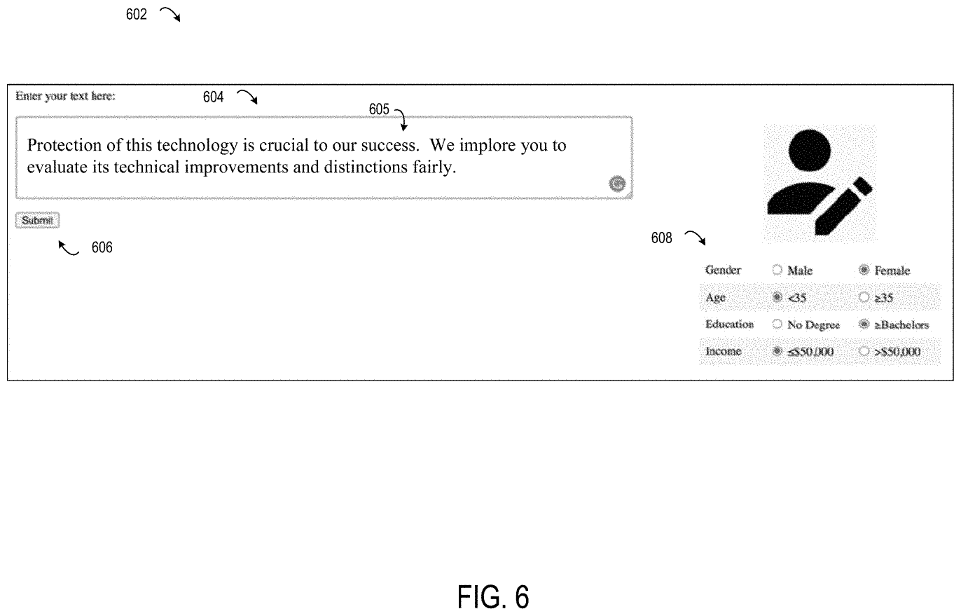

The text processing system 102 communicates with a user device 118 via a user interface engine 106. The user interface engine 106 executes program code that provides a graphical interface, such as an editing interface, to a user device 118 for display. The user interface engine 106 also executes program code that receives input, such as the interaction data 116, via such a graphical interface and provides the input to the BERT-based response prediction model 104. The user interface engine 106 also executes program code that generates outputs, such as the emotion prediction 110 from the BERT-based response prediction model 104 and updates the graphical interface to include the output. Some examples of the interaction data 116 include input text from a user device 118 and demographic information, such as age, gender, income, education, etc. The input text could be entered into a text-editing field in a graphical interface, included in a document that is identified for uploading via a field or menu element of the graphical interface, or some combination thereof. Examples of graphical interfaces that are generated or used by the user interface engine 106 are described herein with respect to FIGS. 6-8.

In some embodiments, the machine-learning tools described herein can also improve, for example, conversational artificial intelligence tools. For instance, in conversational artificial intelligence tools, it can be helpful to ensure that there is appropriate connotation in the way a message is sent to a user and inferred based on the user preferences. If, for example, a user reacts poorly to a message that is automatically generated by conversational artificial intelligence software (e.g., a chatbot), then the user would be less likely to engage with the tool, thereby decreasing its functionality. This problem could be address by the machine-learning tools described herein. For instance, the text processing system 102 could be included in, or accessible to, a conversational artificial intelligence tool. The text processing system 102 could evaluate a message that is automatically generated by a conversational artificial intelligence tool prior to that message being transmitted to a user device associated with a reader. If the evaluated message has an empathy score that exceeds a threshold score (e.g., a user-specified threshold or a threshold learned via machine-learning techniques), the conversational artificial intelligence tool can proceed with transmitting the message to a user device. If the evaluated message has an empathy score that is less than the threshold score, the conversational artificial intelligence tool can modify the message, have the text processing system 102 reevaluate the message with the BERT-based response-prediction model, and then proceed with transmitting the message to the user device if the modifications increase the empathy score beyond the threshold. Additionally or alternatively, messages having distress scores above a threshold could be modified and reevaluated before transmission, and messages having distress scores below a threshold can be transmitted to user devices.

In additional or alternative embodiments, the combination of editing tools, such as those depicted in FIGS. 6-8, with the BERT-based response prediction model described herein with respect to FIGS. 1-5 allows for customizing text to different expected audiences. For instance, different audiences have varying calibrations in terms of their reactions to the same content. These preferences and calibrations are likely to alter their response to a given message. The tools described herein allow for customizing the emotional response (e.g., empathy score, distress score, etc.) for a given audience. This can lead to demographic-specific lead identification when, for example, considering how to draft persuasive writing (e.g., targeted campaigns and marketing messages). For instance, a piece of text has a higher empathy score for a given user group then it is likely to be well received. If it tends to invoke distress, the message may have to be rejected and not used for the persuasive writing. The output of this technology can hence be used while reviewing a piece of persuasive writing (e.g., marketing message) before it is shared with the audience or published.

FIG. 2 depicts an example of a process 200 for using BERT-based machine-learning tools for predicting emotional responses to text. In some embodiments, one or more computing devices implement operations depicted in FIG. 2 by executing suitable program code (e.g., the BERT-based response prediction model 104). For illustrative purposes, the process 200 is described with reference to certain examples depicted in the figures. Other implementations, however, are possible.

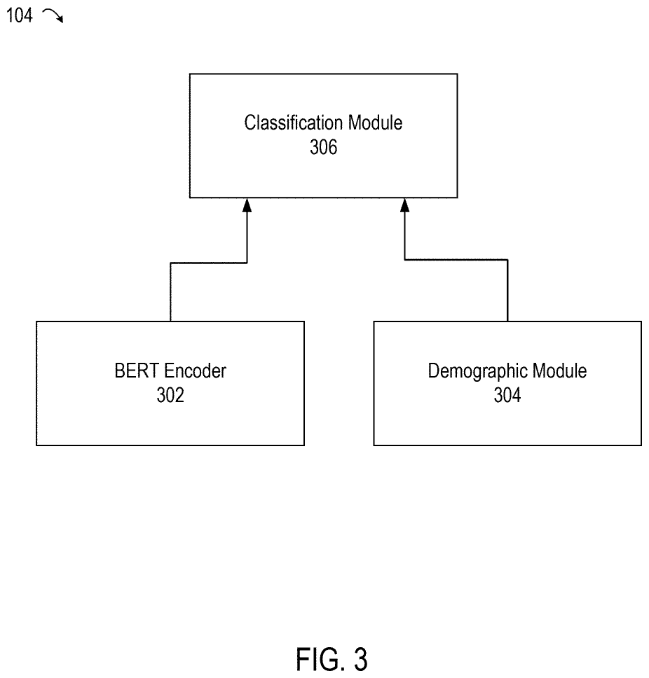

At block 202, the process 200 involves the text processing system 102 providing a set of input text to a machine-learning model having a BERT encoder and a classification module that is trained to predict demographically specific emotional responses. For instance, the text processing system 102 could receive the input text via a graphical interface provided by the user interface engine 106. Examples of the BERT encoder and the classification module are described herein with respect to FIG. 3.

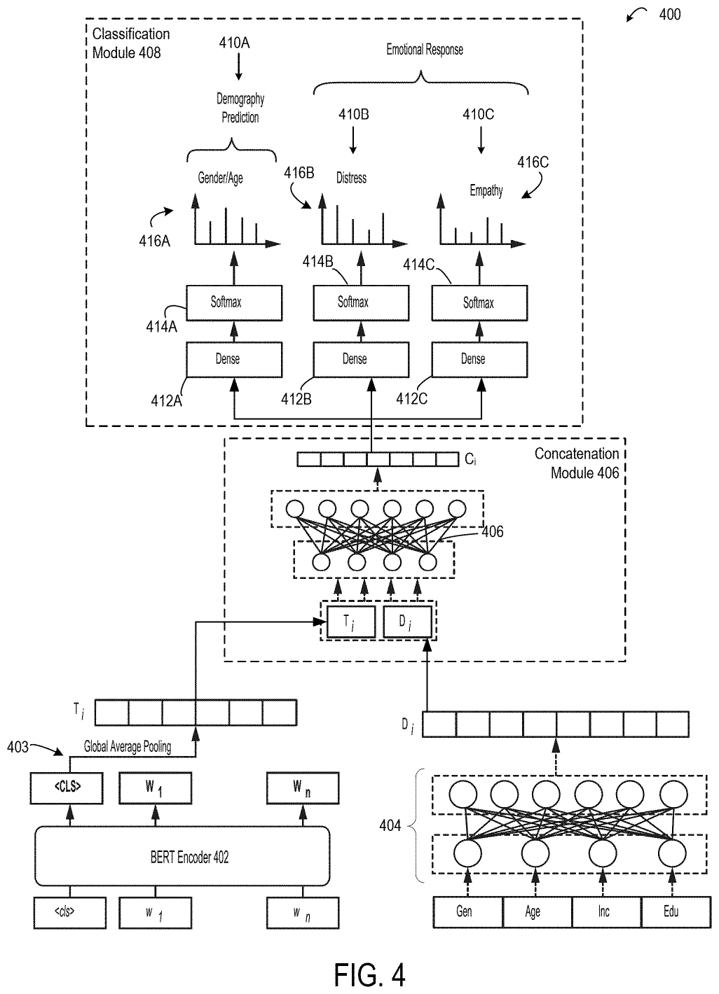

One or more operations in blocks 204 and 206 implement a step for computing, with a BERT-based machine-learning model, a demographically-specific emotional response score from input text. For instance, at block 204, the process 200 involves the text processing system 102 encoding, with the BERT encoder, the input text into an input text vector. For instance, the BERT-based response prediction model 104 applies the BERT encoder to a set of input text. The BERT encoder is trained to encode input text in a manner that, for example, accounts for linguistic variations between different demographic groups. For instance, the BERT encoder includes a set of parameter values obtained from demography-specific sets of training data, as described herein with respect to FIG. 5. The BERT encoder thereby generates and outputs an input text vector that is an encoded version of the input text. Examples of generating the input text vector are described herein with respect to FIGS. 3 and 4.

At block 206, the process 200 involves the text processing system 102 generating an emotional response score for a reader by applying the classification module to the input text vector and an input demographics vector. For instance, the text processing system 102 could receive demographic data for a target reader via a graphical interface provided by the user interface engine 106. The text processing system 102 encodes the demographic data into an input demographics vector. Examples of generating the input demographics vector are described herein with respect to FIGS. 3 and 4. In some embodiments, the BERT-based response prediction model 104 includes one or more neural networks or other operators that concatenate, or otherwise combine, the input text vector and the input demographics vector.

The text processing system 102 applies the classification module to the combined input text vector and input demographics vector and thereby computes an emotional response score. The classification module includes one or more classification heads. A classification head includes a set of layers (e.g., dense layers followed by a softmax layer) that are trained, via a fine-tuning phase of a training process, to compute an output value from the combined input text vector and input demographics vector. For instance, applying the classification module to the input text vector and the input demographics vector could involve providing the combined input vector as an input to a dense layer set in the classification module and computing the emotional response score with a softmax layer connected to the output of the dense layer set. Examples of an emotional response score include one or more of an empathy response score and a distress response score. In some embodiments, the BERT-based response prediction model 104 also computes an output value that is a prediction of one or more demographics of an author of the input text. Examples of implementing the operations in block 206 are provided herein with respect to FIGS. 3 and 4.

At block 208, the process 200 involves the text processing system 102 outputting the emotional response score. For example, the text processing system 102 could update an interface of a text-editing tool, from which the input text is obtained, to identify a predicted emotional response for the input text (e.g., a degree of empathy induced in a reader, a degree of distress induced in a reader, etc.). Updating the interface in this manner facilitates, for example, editing the input text to modify the predicted emotional response. Examples of implementing the operations in block 208 are provided herein with respect to FIGS. 6-8.

FIG. 3 depicts an example of a BERT-based response prediction model 104 for predicting, from a set of input text, one or more of an empathy response and a distress response, according to certain embodiments described in the present disclosure. As illustrated in FIG. 3, the BERT-based response prediction model 104 includes various components including a BERT encoder 302, a demographic module 304, and a classification module 306. In some embodiments, the BERT-based response prediction model 104 includes a greater amount of, or lesser amount of, components for predicting the empathy response and the distress response.

The BERT encoder 302 is a trained neural network that receives, as an input, a series of text such as words. The BERT encoder 302 transforms the words of the input text into a vector for subsequent input into the classification module 306. The vector for subsequent input can be of any size or dimension, and in one such example, the BERT encoder 302 transforms the input text into a vector of dimension 768.

The demographic module 304 receives, as an input, demographic information. In some embodiments, the demographic module 304 is a neural network. The input demographic information includes information relating to age, race, income, education, and any other relevant demographic information. The input demographic information corresponds to demographic information of at least one individual for whom the BERT-based response prediction model 104 is being used to determine emotion-based predictions. The demographic module 304 may output a vector of demographic values for subsequent input into the classification module 306. For example, the demographic module 304 receives a set of demographic values, maps the demographic values to an output demographic vector, and outputs the demographic vector for subsequent use.

The classification module 306, as illustrated, receives, as an input, the outputs of the BERT encoder 302 and the demographic module 304. In some embodiments, the classification module 306 receives the output vector from the BERT encoder 302 and the output vector from the demographic module 304 and determines at least one predictive output relating to emotion. Examples of the predictive output include an empathy response score indicating a level of empathy induced in a reader by an input text and a distress response score indicating a level of distress induced in a reader by an input text. For instance, the classification module 306 may determine that, based on the input vectors from the BERT encoder 302 and the demographic module 304, an empathy of an individual reading the initial text input into the BERT encoder 302 will be high and a distress of the individual will be low.

FIG. 4 depicts an example of an architecture 400 for implementing the BERT-based response prediction model 104 from FIG. 3. In this example, the architecture 400 includes a BERT encoder 402, a feed-forward neural network 404, a concatenation module 406, and a classification module 408.

The text processing system 102 applies the BERT encoder 402 to a set of input text. The BERT encoder 402, or another software component, tokenizes one or more text sequences from the input text into a set of tokens w₁ . . . wₙ. A text sequence is a set of contiguous text, such as, but not limited to, a sentence. The BERT encoder 402 outputs a vector Tᵢ that is an encoded version of the input text. The text processing system 102 provides the vector Tᵢ, as an input, to the concatenation module 406.

In one example, the BERT encoder 402 is implemented using a multi-layer bidirectional transformer encoder (e.g., a twelve-layer transformer). An input to the BERT encoder 302 is a classification token cls followed by a text sequence that includes the word tokens w₁ . . . wₙ. The BERT encoder 302, which generates a sequence of hidden states from an inputted text sequence, outputs a set of vectors corresponding to the classification token CLS and word tokens W₁, . . . Wₙ. The vector representing a final hidden state that corresponds to the classification token CLS is the input text vector that can be provided to the classification module 408, either directly or via a concatenation module 406. The classification module 306 uses this input text vector representing the final hidden state as the aggregate sequence representation for a given inputted text sequence. In one example, a global average pooling layer 403 generates a 768-dimensional hidden vector Tᵢ corresponding to the CLS token from the BERT encoder 402. This vector Tᵢ is an aggregate sequence representation of the input text.

The concatenation module 406 also receives, from the feed-forward neural network 404, a vector Dᵢ. The vector Dᵢ is an encoded version of demographic information. For example, the text processing system 102 could receive the demographic information via one or more user inputs, such as the inputs to one or more user interfaces depicted in FIGS. 5-7. The feed-forward neural network 404 is trained to encode the received demographic information into the vector Dᵢ. For example, in FIG. 4, the nodes and layers of the feed-forward neural network 404 map input data identifying demographic information to an output layer that generates the vector Dᵢ. Independent demographic features can be combined into a shared space using a feed-forward neural network 404. As depicted in FIG. 4, examples of the received demographic information include gender, age, income, and education. But any suitable demographics can be used with the BERT-based response prediction model 104.

In some embodiments, the feed-forward neural network 404 can be omitted. In such embodiments, rather than using a feed-forward neural network to generate a vector Dᵢ, an encoder receives the demographic data and generates a one-hot encoding vector having d dimensions, where d is the number of demographic attributes. For instance, a four-dimensional vector Dᵢ could be used to represent, via one-hot encoding, the four demographic attributes gender, age, income, and education.

The concatenation module 406 generates a combined vector Cᵢ. The vector Cᵢ represents a combination of the encoded text information in the vector Tᵢ from the BERT encoder 402 and the encoded demographics information in vector Dᵢ from the feed-forward neural network 404. To generate the vector Cᵢ, the concatenation module 406 applies a feed-forward network 404 to the input vectors Tᵢ and Dᵢ and thereby performs a concatenation operation on these vectors. For example, an input layer of the feed-forward network 404 receives the vectors Tᵢ and Dᵢ. The nodes and layers of the feed-forward network 404 map the components of the input vectors Tᵢ and D₁ to an output layer that generates the vector Cᵢ.

The text processing system 102 uses the classification module 408 to generate one or more predictive outputs represented using probability distributions 416a-c (e.g., empathy response scores, distress response scores, author demography). The classification module 408 includes multiple classification heads 410a-c that respectively include dense layer sets 412a-c connected to softmax layers 414a-c. A dense layer set includes one or more stacked dense layers. A softmax layer outputs a probability distribution of predicted output classes. As depicted in FIG. 4, the different classification heads 410a-c have shared BERT layers (i.e., the BERT encoder 402). However, each of the classification heads has a respective dense layer set and softmax layer that is specific to the task.

For instance, the dense layer sets 412a and softmax layer 414a of the classification head 410a are trained to map the text and input demographic information represented by the vector Cᵢ to an output value that is a prediction of one or more demographics of an author of the input text. In the example depicted in FIG. 4, the softmax layer 414a outputs a probability distribution 416a with probabilities for different output classes, such as demographic groups (e.g., male with a first education level, male with a second education level, female with the first education level, female with the second education level). In some embodiments, the text processing system 102 selects the output class (i.e., a demographic profile) having a highest probability as the predicted demographic for the author of the input text. In additional or alternative embodiments, the text processing system 102 selects the output class (i.e., a demographic profile) having a highest probability as the predicted demographic for the author of the input text if the highest probability exceeds a threshold probability (e.g., 50%).

The dense layer sets 412b and softmax layer 414b of the classification head 410b are trained to map the text and input demographic information represented by the vector Cᵢ to a distress response score. The distress response score indicates a predicted level of distress induced, by the input text, in a reader having the input demographics. In the example depicted in FIG. 4, the softmax layer 414b outputs a probability distribution 416b with probabilities for different output classes, such as distress scores. As a simplified example, each output class could be a different distress score, such as a set of ten output classes respectively representing distress scores of 1, 2, . . . 10. In some embodiments, the text processing system 102 selects the output class (i.e., a distress score) having a highest probability as the distress response score for the input text. In additional or alternative embodiments, the text processing system 102 selects the output class (i.e., a distress score) having a highest probability as the distress response score for the input text if the highest probability exceeds a threshold probability (e.g., 50%).

The dense layer sets 412c and softmax layer 414c of the classification head 410c are trained to map the text and input demographic information represented by the vector Cᵢ to an empathy response score. The empathy response score indicates a predicted level of empathy induced, by the input text, in a reader having the input demographics. In the example depicted in FIG. 4, the softmax layer 414c outputs a probability distribution 416c with probabilities for different output classes, such as empathy scores. As a simplified example, each output class could be a different empathy score, such as a set of ten output classes respectively representing empathy scores of 1, 2, . . . 10. In some embodiments, the text processing system 102 selects the output class (i.e., an empathy score) having a highest probability as the empathy response score for the input text. In additional or alternative embodiments, the text processing system 102 selects the output class (i.e., an empathy score) having a highest probability as the empathy response score for the input text if the highest probability exceeds a threshold probability (e.g., 50%).

The training engine 122 configures a BERT-based response prediction model 104 for predicting emotional responses based on demographic profiles. Some operations of the process 500 include adapting the BERT-based response prediction model to demographic preferences, modifying the BERT-based response prediction model for an emotional response classification task (e.g., empathy or distress), and iteratively performing the training process and computing a loss for each iteration using a binary cross entropy loss function.

For instance, FIG. 5 depicts an example of a process 500 for training a BERT-based response prediction model to generate emotional response scores. FIG. 2 depicts an example of a process 200 for using BERT-based machine-learning tools for predicting emotional responses to text. In some embodiments, one or more computing devices implement operations depicted in FIG. 2 by executing suitable program code (e.g., the BERT-based response prediction model 104). For illustrative purposes, the process 200 is described with reference to certain examples depicted in the figures. Other implementations, however, are possible.

At block 502, the process 500 involves the training engine 122 accessing a training dataset that includes training text data with varied demographic attributes and labeled training text. An example of training text data with varied demographic attributes includes first input text (or input text vectors into which the first input text is encoded) having a first value of a demographic attribute for one or more authors of the first input text and second input text (or input text vectors into which the second input text is encoded) having a second value of the demographic attribute for one or more authors of the second input text. For instance, the first input text could be text authored by females, and the second input text could be text authored by males. The labeled training text includes additional input text (training input text vectors into which the additional input text is encoded) along with ground truth outputs. One example of a ground truth output for a certain set of training input text (or its training input text vector) is an emotional response score, such as an empathy response score or a distress response score. Another example of a ground truth output for a certain set of training input text (or its training input text vector) is a demography prediction, such as an output identifying one or more demographic attributes of an author of the set of training input text.

At block 504, the process 500 involves the training engine 122 performing first iterations that modify parameters of a BERT encoder based on a training set of first input text having a first value for a demographic attribute. In the example noted above, the training engine 122 trains the BERT encoder using text authored by females at block 504. The first input text can be unlabeled, in that no ground truth output (e.g., demography prediction, emotional response score, etc.) is used at block 504.

At block 506, the process 500 involves the training engine 122 performing second iterations that modify parameters of the BERT encoder based on a training set of second input text having a second value for a demographic attribute. In the example noted above, the training engine 122 trains the BERT encoder using text authored by males at block 506. Here again, the second input text can be unlabeled, in that no ground truth output (e.g., demography prediction, emotional response score, etc.) is used at block 506.

In some embodiments, block 504 and 506 are included in a pre-training phase for the BERT-based response prediction model 104. In a pre-training phase, the training engine 122 trains the BERT-based response prediction model 104 on unlabeled data over different pre-training tasks. In a first pre-training task, the training engine 122 masks some percentage of the input tokens w₁ wₙ at random, and then, in blocks 504 and 506, modifies one or more parameters of the BERT encoder to improve predictions of those masked tokens. In a second pre-training task, the training engine 122 modifies parameters of the BERT encoder, in blocks 504 and 506, to accurately understand and classify the relationship between two sentences, which is not directly captured by language modeling. For instance, the training engine 122 configures the BERT encoder for a binarized next sentence prediction task.

As noted in the examples above, in this pre-training phase, the training engine 122 performs the various training tasks using multiple training sets of demographically varied input text. For instance, a first set of input text has a first value for a demographic attribute of an author (e.g., input text authored by females) and a second set of input text has a second value for the demographic attribute (e.g., input text authored by males). These demographic-specific datasets allow the training engine 122 to train the BERT encoder 302 to predict outcomes (e.g., masked tokens, next sentence, etc.) that reflect demographic-specific language preferences. For instance, training the BERT encoder 302 without regard to demographics could cause a set of probabilities that certain words are used together to be skewed toward a single demographic group. However, using demographic-specific datasets allows these probabilities to reflect variations in language usage that result from, or are at least correlated with, variations in demographic profiles. In some embodiments, the training set of input text used by the training engine 122 in the pre-training phase is different from the training set of input text used by the training engine 122 in the fine-tuning phase.

At block 508, the process 500 involves the training engine 122 performing additional iterations that modify parameters of one or more classification heads of the BERT-based response prediction model based on training input text vectors and training input demographics vectors. For example, block 508 could include a fine-tuning phase of the training process. In the fine-tuning phase, the training engine 122 initializes the BERT-based response prediction model 104 with the parameters identified in the pre-training phase and then modifies the parameters of the BERT-based response prediction model 104, including parameters of the classification module 306, to generate predict outputs (e.g., emotional response scores, demography predictions) that match ground truth inputs. For instance, the initialized parameters include the parameter values for the BERT encoder 302 learned from the masked token prediction task and the next sentence prediction task. The training engine 122 updates, in the fine-tuning phase, one or more parameters of the BERT-based response prediction model 104 using labeled data from downstream tasks. Each downstream task (e.g., distress prediction, empathy prediction, demography prediction) has a separate classification head.

In some embodiments, the training engine 122 performs alternative training during the fine-tuning phase. In alternative training, the training engine 122 iteratively trains a first classification head, with the parameter values of the other classification heads remaining constant throughout these. The training engine 122 then iteratively trains a second classification head, with the parameter values of the other classification heads remaining constant throughout these. The training engine 122 continues in this manner to train each classification head individually.

In additional or alternative embodiments, the training engine 122 performs parallel training during the fine-tuning phase. In parallel training, the training engine 122 iteratively trains the BERT-based response prediction model 104 end-to-end. For instance, the training engine 122 performs a first iteration, modifies parameter values for multiple classification heads (e.g., the dense layer parameter values for a distress classification head as well as the dense layer parameter values for an empathy classification head), and then performs a second iteration. The training engine 122 computes a loss value for each iteration using a joint loss function.

At block 510, the process 500 involves the training engine 122 selecting a first parameter value set for the BERT encoder and a second parameter value set for one or more classification heads. The first parameter value set and the second parameter value set are computed with the training process performed in blocks 504-508.

For instance, the training engine 122 computes loss values for iterations of the training process, respectively. The training engine 122 computes a loss value for a given iteration by applying a binary cross entropy loss function to one or more ground truth outputs and one or more training emotional response scores. A ground truth input, such as a “true” emotional response score, is a label provided by one or more users for a set of input training data. The ground truth input corresponds to one or more training input text vectors and one or more training input demographics vectors. For instance, if a set of training text is labeled with a certain emotional response score representing the emotional response for a certain demographic profile, that label is the ground truth input that corresponds to a training input text vector computed from the set of training text (e.g., using the BERT encoder 302) and a training input demographics vector computed from the demographic profile (e.g., using the demographic module 304). A training emotional response score is an emotional response score that is generated by applying the BERT encoder and the classification head to a set of input training data (e.g., training input text vectors and the training input demographics vectors).

The training engine 122 uses the loss values to identify a desirable set of parameter values for the BERT-based response prediction model 104. For instance, the training engine 122 identifies one of the loss values that is less than one or more other loss values (e.g., a minimum loss value). The training engine 122 selects the parameter values of the BERT-based response prediction model 104 for the iteration of the training process that resulted in the identified loss value (e.g., the minimum loss value). The training engine 122 uses the selected parameter values (e.g., the first parameter value set for the BERT encoder and the second parameter value set for one or more classification heads) as the configuration of the BERT-based response prediction model 104 to be outputted from the trained process.

As noted above with respect to block 506, various embodiments involve the training engine performing alternative training or parallel training. In embodiments involving alternative training, the training engine 122 can apply a binary cross entropy loss function by performing a step for computing a single-task loss for the BERT-based response prediction model. An example of computing a single-task loss for the BERT-based response prediction model is computing a loss L_{CE} using the following formula:

$${L}_{CE} = - \frac{1}{N} {\sum }_{i = 1}^{N} {y}_{i} * log {\hat{y}}_{i} + ( 1 - {y}_{i} ) * ( 1 - log {\hat{y}}_{i} ) . \qquad ( 1 )$$

In Equation (1), N is the number of training samples. For instance, a training sample i includes a set of input text or its input text vector and a demographic profile or its input demographics vector. Furthermore, the term ŷᵢ represents a ground truth output corresponding to the training sample i, and the term yᵢ represents the task output (e.g., an emotional response score or demography prediction) computed by the BERT-based response prediction model for a given training sample i.

In embodiments involving parallel training, the training engine 122 can apply a binary cross entropy loss function by performing a step for computing a multi-task loss for the BERT-based response prediction model. An example of computing a multi-task loss for the BERT-based response prediction model is computing a loss mtL_{CE} using the following formula:

$${mtL}_{CE} = - \frac{1}{N} {\sum }_{i = 1}^{N} \frac{1}{\vert T \vert} {\sum }_{t ∈ T} {y}_{i}^{t} * {log y}_{i}^{t} + ( 1 - {y}_{i}^{t} ) * log ( 1 - {y}_{i}^{t} ) . \qquad ( 2 )$$

Here again, in Equation (2), N is the number of training samples, the term ŷᵢ represents a ground truth output corresponding to the training sample i, and the term yᵢ represents the task output (e.g., an emotional response score or demography prediction) computed by the BERT-based response prediction model for a given training sample i. Furthermore, the term t is an index for a particular task, and the term T indicates the number of tasks. For instance, T=3 in a BERT-based response prediction model 104 having three classification heads that respectively compute demography predictions, empathy response scores, and distress response scores.

At block 512, the process 500 involves the training engine 122 outputting the BERT-based response prediction model having the first parameter value set and the second parameter value set. In some embodiments, outputting the BERT-based response prediction model involves the training engine 122 configuring a first computing system, such as a computing device in a training system 120, to transmit program code, data, or both that implement the trained BERT-based response prediction model to a second computing system, such as a computing device in a text processing system 102. In additional or alternative embodiments, outputting the BERT-based response prediction model involves the training engine 122 configuring a first computing system, such as a computing device in a training system 120, to store program code, data, or both that implement the trained BERT-based response prediction model in a location on a non-transitory computer-readable medium that is accessible to a second computing system, such as a computing device in a text processing system 102.

Examples of Graphical Interfaces Used with BERT-Based Response Prediction Model

FIG. 6 depicts an example of a user interface generated by a text processing system that uses a BERT-based response prediction model, according to certain embodiments described in the present disclosure. In FIG. 6, an editing interface 602 of a text editing tool includes an editing field 604, a submit button 606, and one or more input elements 608 for inputting a demographic profile. The editing interface 602 can be generated by, updated by, or otherwise modified by a user interface engine 106.

The user interface engine 106 or other suitable software could detect input text 605 entered into the editing field 604. The detection could include an event listener of the editing field 604 receiving user input specifying the input text 605, an event listener of the submit button 606 retrieving the input text 605, or some combination thereof.

The user interface engine 106 or other suitable software could also detect an input demographic profile that is specified via one or more input elements 608. The detection could include one or more event listeners of one or more input elements 608 receiving user input specifying values for different demographic attributes, an event listener of the submit button 606 retrieving the inputted values of the different demographic attributes, or some combination thereof. Although FIG. 6 depicts input elements 608 as a set of radio buttons, other interface elements (e.g., drop-down menu, text field, etc.) could be used to input values for different demographic attributes.

The user interface engine 106 or other suitable software provides the detected input text and detected input demographic profile to the BERT-based response prediction model 104, which performs one or more operations described above with respect to FIGS. 2-4. For instance, clicking the submit button 606 can instruct the text processing system 102 to perform one or more operations from the process 200.

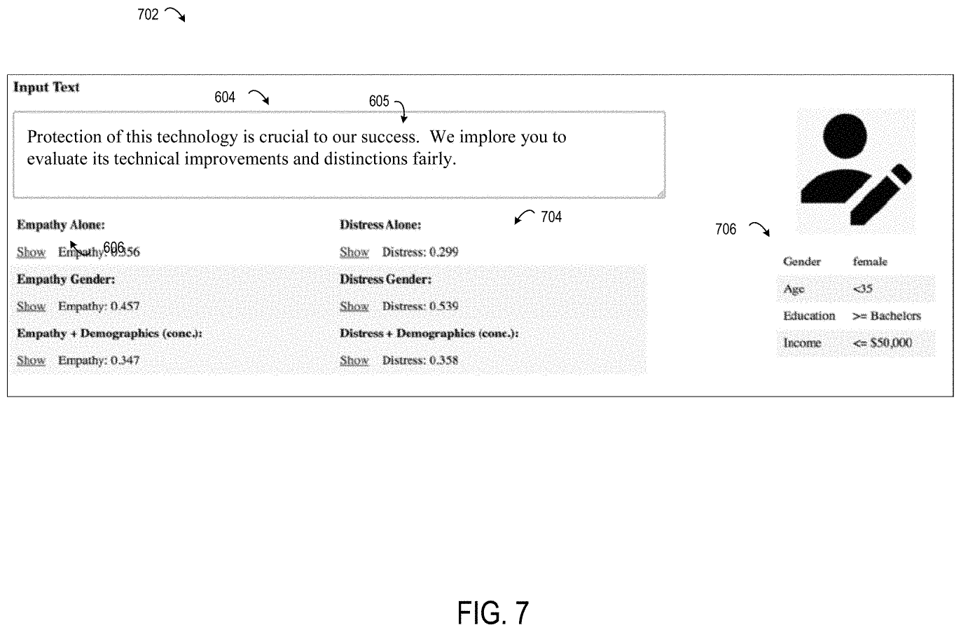

The user interface engine 106 or other suitable software updates the editing interface to include the emotional response score adjacent to the editing field. For instance, FIG. 7 depicts another example of a user interface generated by the text processing system 102 that uses a BERT-based response prediction model. The editing interface 702 can be generated by, updated by, or otherwise modified by using a user interface engine 106. In FIG. 7, the editing interface 702 of the text editing tool includes the editing field 604 from which input text 605 was detected, an emotional response score section 704, and a demographic profile section 706. The emotional response score section 704 identifies the computed empathy response and distress response for the submitted input text 605 and the submitted demographic information displayed in the demographic profile section 706.

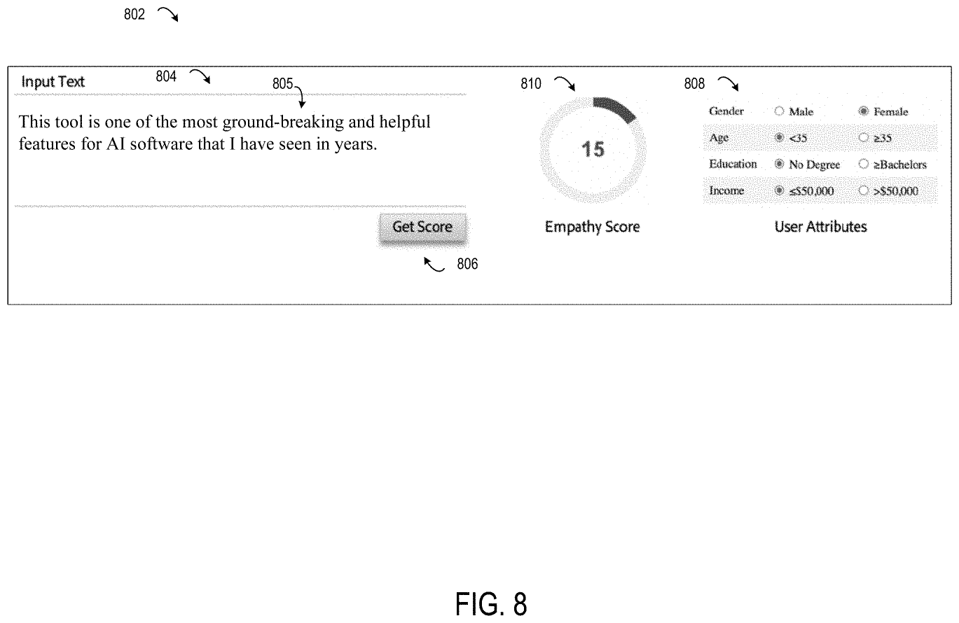

FIG. 8 depicts another example of a user interface generated by a text processing system that uses a BERT-based response prediction model. In FIG. 8, an editing interface 802 of a text editing tool includes an editing field 804, a submit button 806, one or more input elements 808 for inputting a demographic profile, and an emotional response score section 810. The editing interface 802 can be generated by, updated by, or otherwise modified by a user interface engine 106.

The user interface engine 106 or other suitable software could detect input text 805 entered into the editing field 804. The detection could include an event listener of the editing field 804 receiving user input specifying the text, an event listener of the submit button 806 retrieving the input text 805, or some combination thereof.

The user interface engine 106 or other suitable software could also detect an input demographic profile that is specified via one or more input elements 808. The detection could include one or more event listeners of one or more input elements 808 receiving user input specifying values for different demographic attributes, an event listener of the submit button 806 retrieving the inputted values of the different demographic attributes, or some combination thereof. Although FIG. 8 depicts input elements 808 as a set of radio buttons, other interface elements (e.g., drop-down menu, text field, etc.) could be used to input values for different demographic attributes.

The user interface engine 106 or other suitable software provides the detected input text 805 and detected input demographic profile to the BERT-based response prediction model 104, which performs one or more operations described above with respect to FIGS. 2-4. For instance, clicking the submit button 806 can instruct the text processing system 102 to perform one or more operations from the process 200.

The user interface engine 106 or other suitable software updates the editing interface to include the emotional response score adjacent to the editing field. For instance, in FIG. 8, the emotional response score section 810 identifies the computed empathy response and distress response for the submitted text and the submitted demographic information specified via one or more input elements 808.

In some embodiments, an editing interface can be updated in real time to identify how changes in input text or demographic profiles can modify a predicted emotional response. For instance, a user interface engine or other software could detect a modification to the input text in an editing field of an editing interface. The text processing system 102 could apply a BERT-based response prediction model and update the interface responsive to detecting the modification to the input text (e.g., without requiring a “submit” button to be clicked). In one example, a text processing system 102 could include software that monitors an editing field for the entry of certain characters, such as a period or a comma, or other inputs (e.g., a line break indicating the start of a new paragraph). The text processing system 102 could respond to the entry of the monitored characters by applying a BERT-based response prediction model and updating the editing interface to display a modified emotional response. In this manner, an end user could receive feedback on the predicted emotional response contemporaneously with the user entering certain text, thereby allowing the user to quickly assess which edits to the text would increase or decrease the predicted emotional response invoked in a potential reader.

Additionally or alternatively, a user interface engine or other software could detect a modification to the demographic profile specified via the editing interface. The text processing system 102 could apply a BERT-based response prediction model and update the interface responsive to detecting the modification to the demographic profile (e.g., without requiring a “submit” button to be clicked).

Examples of Architectures for BERT Encoder

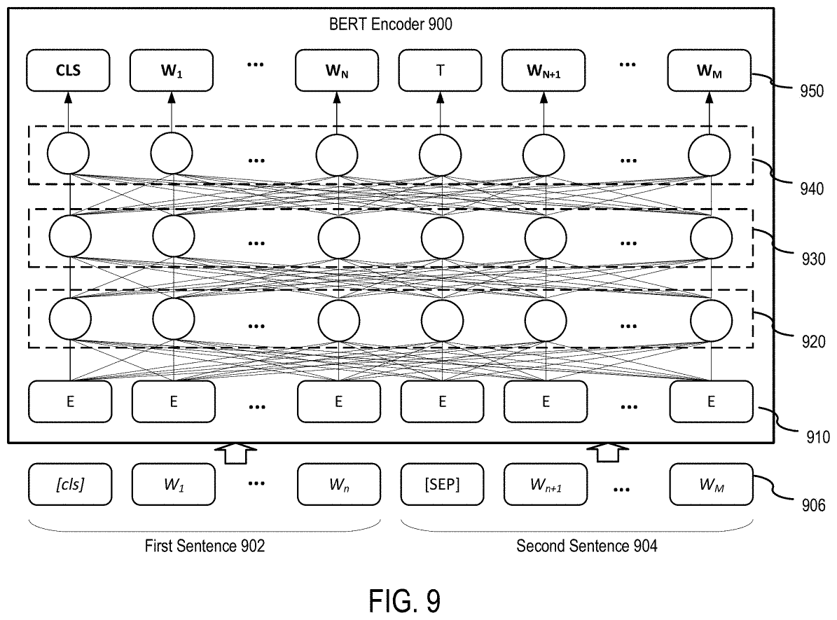

Any suitable architecture can be used for implementing the BERT encoders discussed above. For example, FIG. 9 depicts an example of a BERT encoder 900 that could be used to implement the BERT encoder 302 in FIG. 3 or the BERT encoder 402 in FIG. 4. In this example, the BERT encoder 900 is implemented as a multi-layer bidirectional Transformer encoder. The BERT encoder 900 receives, as inputs, tokens 906 (e.g., the word tokens w₁ . . . wₙ from FIG. 4). Sequences of tokens represent sentences, such as a first sentence 902 and a second sentence 904. The text processing system 102 or another suitable computing system embeds the tokens 906 into vectors 910. The vectors 910 are processed by encoder layers 920, 930, and 940 to generate a set of vectors 950 that represent the classification token CLS and word tokens W₁, . . . Wₙ.

The encoder layers 920, 930, and 940 may form a multi-layer perceptron. Each of the encoder layers 920, 930, and 940 could include a multi-head attention model and/or fully connected layer. An attention function may map a query and a set of key-value pairs to an output, where the query, keys, values, and output are all vectors. A query vector q encodes the word/position that is paying attention. A key vector k encodes the word to which attention is being paid. The key vector k and the query vector q together determine the attention score between the respective words. The output is computed as a weighted sum of values, where the weight assigned to each value is computed by a compatibility function of the query with the corresponding key. A multi-head attention model may include multiple dot-product attentions. Operations of the encoder layer 920, 930, and 940 could include a tensor operation that can be split into sub-operations that have no data dependency between each other and thus can be performed by multiple computing engines (e.g., accelerators) in parallel.

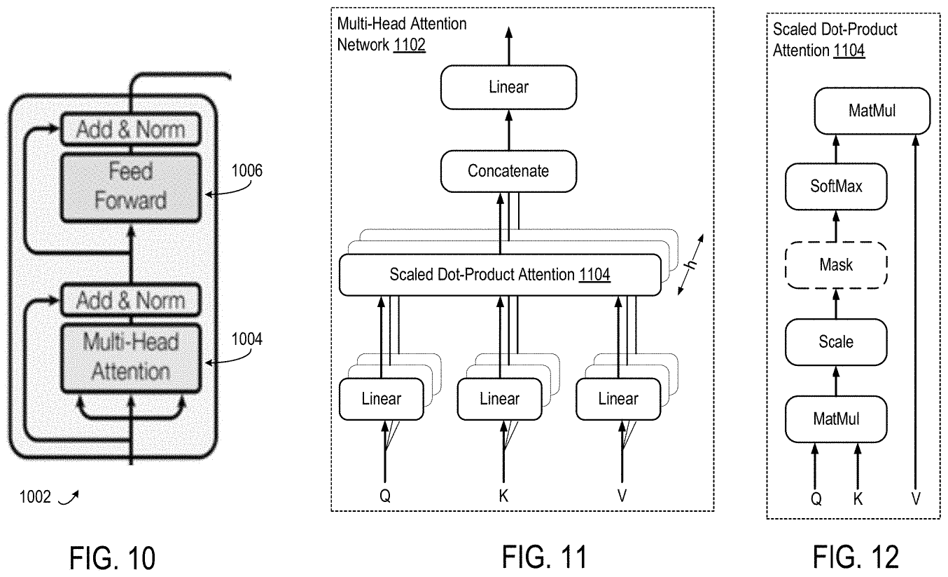

FIG. 10 illustrates an example of an encoder layer 1002. The architecture depicted in FIG. 10 can be used to implement one or more of the encoder layers 920, 930, and 940 from FIG. 9. The encoder layer 1002 includes two sub-layers that perform matrix multiplications and element-wise transformations. The first sub-layer may include a multi-head self-attention network 1004 and the second sub-layer may include a position-wise fully connected feed-forward network 1006. A residual connection may be used around each of the two sub-layers, followed by layer normalization. A residual connection adds the input to the output of the sub-layer, and is a way of making training deep networks easier. Layer normalization is a normalization method in deep learning that is similar to batch normalization. The output of each sub-layer may be written as LayerNorm(x+Sublayer(x)), where Sublayer(x) is the function implemented by the sub-layer. In the encoder phase, the Transformer first generates initial inputs (e.g., input embedding and position encoding) for each word in the input sentence. For each word, the self-attention aggregates information from all other words (pairwise) in the context of the sentence to create a new representation for each word that is an attended representation of all other words in the sequence. This is repeated for multiple times each word in a sentence to successively build newer representations on top of previous ones.

FIG. 11 illustrates an example of a multi-head self-attention network 1102 that can be as the multi-head self-attention network in FIG. 10. The multi-head self-attention network 1102 linearly projects queries, keys, and values multiple (e.g., h) times with different, learned linear projections to dₖ, dₖ, and dᵥ, respectively. Attention functions are performed in parallel on the h projected versions of queries, keys, and values using multiple (e.g., h) scaled dot-product attention blocks 1104, yielding h dᵣ-dimensional output values. Each attention head may have a structure as shown in FIG. 12, and may be characterized by three different projections given by weight matrices:
Wᵢ^{K} with dimensions d_{model}×dₖ
Wᵢ^{Q} with dimensions d_{model}×dₖ
Wᵢ^{V} with dimensions d_{model}×dᵥ.

The outputs of the multiple scaled dot-product attentions are concatenated, resulting in a matrix of dimensions dᵢ×(h×dᵥ), where dᵢ is the length of the input sequence. Afterwards, a linear layer with weight matrix W° of dimensions (h×dᵥ)×dₑ is applied to the concatenation result, leading to a final result of dimensions dᵢ×dₑ:

MultiHead(Q,K,V)=Concat(head₁, . . . ,headₕ)W^{O}

where headᵢ=Attention(QWᵢ^{Q},KWᵢ^{K},VWᵢ^{V}) (5)

where dₑ is the dimension of the token embedding. Multi-head attention allows a network to jointly attend to information from different representation subspaces at different positions. The multi-head attention may be performed using a tensor operation, which may be split into multiple sub-operations (e.g., one for each head) and performed in parallel by multiple computing engines.

FIG. 12 illustrates an example of a scaled dot-product attention block 1104 in accordance with some embodiments. In scaled dot-product attention block 1104, the input includes queries and keys both of dimension dₖ, and values of dimension dᵥ. The scaled dot-product attention may be computed on a set of queries simultaneously, according to the following equation:

$$Attention ( Q , K , V ) = softmax ( \frac{{QK}^{T}}{\sqrt{{d}_{k}}} ) V , \qquad ( 4 )$$

where Q is the matrix of queries packed together, and K and V are the matrices of keys and values packed together. The scaled dot-product attention computes the dot-products (attention scores) of the queries with all keys (“MatMul”), divides each element of the dot-products by a scaling factor \sqrt{dₖ} (“scale”), applies a softmax function to obtain the weights for the values, and then uses the weights to determine a weighted sum of the values.

When only a single attention is used to calculate the weighted sum of the values, it can be difficult to capture various different aspects of the input. For instance, in the sentence “I like cats more than dogs,” one may want to capture the fact that the sentence compares two entities, while retaining the actual entities being compared. A transformer may use the multi-head self-attention sub-layer to allow the encoder and decoder to see the entire input sequence all at once. To learn diverse representations, the multi-head attention applies different linear transformations to the values, keys, and queries for each attention head, where different weight matrices may be used for the multiple attention heads and the results of the multiple attention heads may be concatenated together.

Example of a Computing System for Implementing Certain Embodiments

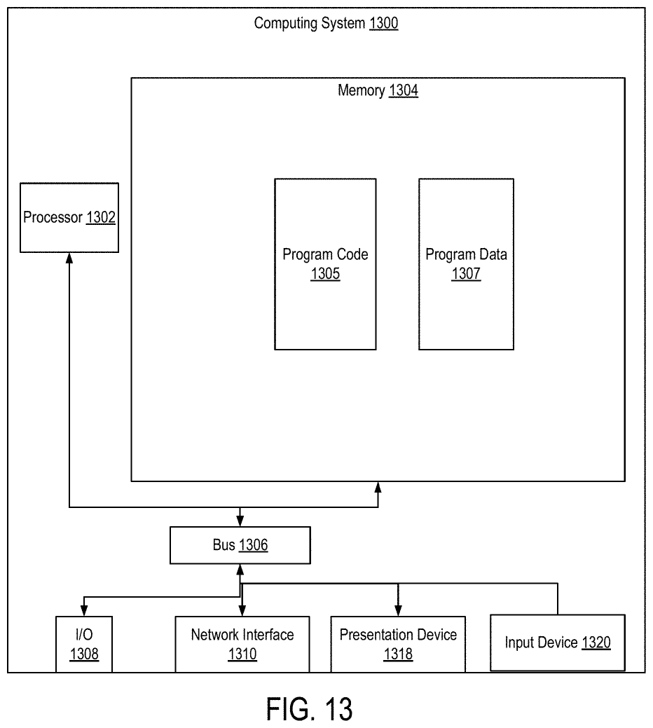

Any suitable computing system or group of computing systems can be used for performing the operations described herein. For example, FIG. 13 depicts an example of the computing system 1300. The implementation of computing system 1300 could be used for one or more of a text processing system 102, a user device 118, and a training system 120. In other embodiments, a single computing system 1300 having devices similar to those depicted in FIG. 13 (e.g., a processor, a memory, etc.) combines the one or more operations and data stores depicted as separate systems in FIG. 1.

The depicted example of a computing system 1300 includes a processor 1302 communicatively coupled to one or more memory devices 1304. The processor 1302 executes computer-executable program code stored in a memory device 1304, accesses information stored in the memory device 1304, or both. Examples of the processor 1302 include a microprocessor, an application-specific integrated circuit (“ASIC”), a field-programmable gate array (“FPGA”), or any other suitable processing device. The processor 1302 can include any number of processing devices, including a single processing device.

A memory device 1304 includes any suitable non-transitory computer-readable medium for storing program code 1305, program data 1307, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 1300 may also include a number of external or internal devices, an input device 1320, a presentation device 1318, or other input or output devices. For example, the computing environment 100 is shown with one or more input/output (“I/O”) interfaces 1308. An I/O interface 1308 can receive input from input devices or provide output to output devices. One or more buses 1306 are also included in the computing system 1300. The bus 1306 communicatively couples one or more components of a respective one of the computing system 1300.

The computing system 1300 executes program code 1305 that configures the processor 1302 to perform one or more of the operations described herein. Examples of the program code 1305 include, in various embodiments, modeling algorithms executed by the text processing system 102 (e.g., functions of the BERT-based response prediction model 104), the user interface engine 106, the training engine 122, or other suitable applications that perform one or more operations described herein. The program code may be resident in the memory device 1304 or any suitable computer-readable medium and may be executed by the processor 1302 or any other suitable processor.

In some embodiments, one or more memory devices 1304 store program data 1307 that includes one or more datasets and models described herein. Examples of these datasets include interaction data, training data, parameter values, etc. In some embodiments, one or more of data sets, models, and functions are stored in the same memory device (e.g., one of the memory devices 1304). In additional or alternative embodiments, one or more of the programs, data sets, models, and functions described herein are stored in different memory devices 1304 accessible via a data network.

In some embodiments, the computing system 1300 also includes a network interface device 1310. The network interface device 1310 includes any device or group of devices suitable for establishing a wired or wireless data connection to one or more data networks. Non-limiting examples of the network interface device 1310 include an Ethernet network adapter, a modem, and/or the like. The computing system 1300 is able to communicate with one or more other computing devices (e.g., a user device) via a data network using the network interface device 1310.

In some embodiments, the computing system 1300 also includes the input device 1320 and the presentation device 1318 depicted in FIG. 13. An input device 1320 can include any device or group of devices suitable for receiving visual, auditory, or other suitable input that controls or affects the operations of the processor 1302. Non-limiting examples of the input device 1320 include a touchscreen, a mouse, a keyboard, a microphone, a separate mobile computing device, etc. A presentation device 1318 can include any device or group of devices suitable for providing visual, auditory, or other suitable sensory output. Non-limiting examples of the presentation device 1318 include a touchscreen, a monitor, a speaker, a separate mobile computing device, etc.

Although FIG. 13 depicts the input device 1320 and the presentation device 1318 as being local to the computing device that executes the text processing system 102, other implementations are possible. For instance, in some embodiments, one or more of the input device 1320 and the presentation device 1318 can include a remote client-computing device that communicates with the computing system 1300 via the network interface device 1310 using one or more data networks described herein.

### Experimental Results

In an experiment involving embodiments described herein, empathy or distress predictions are modeled as a binary classification task. Experimentation was also conducted for empathy (distress)-aware demographic attribute prediction to study the efficacy of empathy (distress) to predict demography attributes.

In a cross-domain pre-training phase, the experimentation used the Blog Authorship Corpus, which consists of blogposts and demographic attributes of the corresponding authors to further pre-train BERT. The BERT-based response prediction model was trained on the Masked Language Model Task for 10 epochs using a learning rate of 3e-5. In a fine-tuning phase, the experiment involved training the model end-to-end (110 million parameters) using binary cross-entropy loss and a decoupled weight decay Adam optimizer, in batches of 32.

The experimentation used gender, age, education and income attributes corresponding to each annotator in the empathy dataset. The d vector representing demographics had four dimensions, resulting in a 16-dimensional feed-forward neural network (“FFN”) output.

The experimentation use five-fold cross validation (by running five random restarts with random shuffling) with 80:20 train-to-test proportions. The experimentation's reports included the F1 and accuracy (“Ac”) averaged across the five runs on the test set.

The experimentation compared the BERT-based machine-learning models, as in certain embodiments described above, against a Random Forest (RF) model with Glove embeddings for text and demographic attributes (excluding the prediction attribute) as one-hot vectors as features. The experimentations reports also include performance of the BERT-based machine-learning models against deep learning baselines, CNN, biLSTM, biLSTM with Attention, the pre-trained BERT without further training.

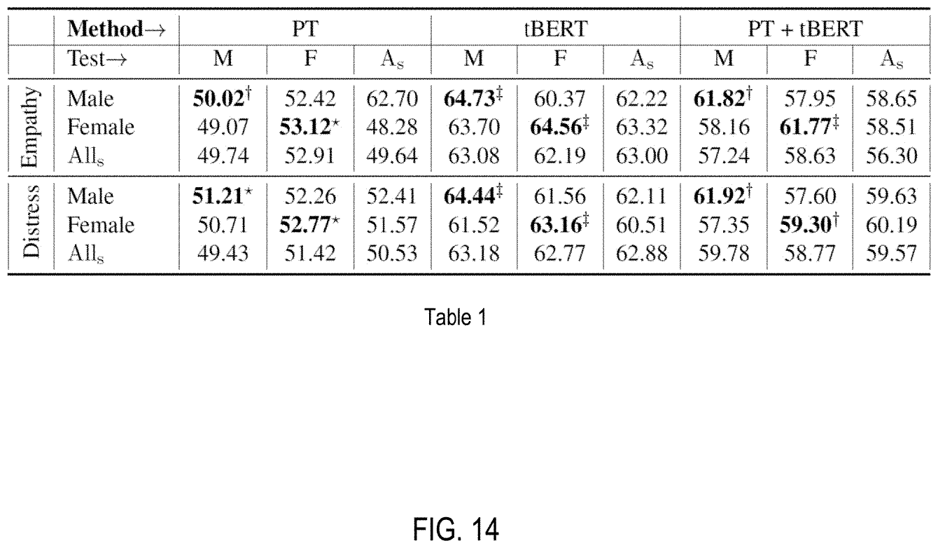

In FIG. 14, Table 1 shows the accuracies using BERT for pre-training (PT), fine-tuning (tBERT), and both (PT+tBERT) for gender-specific empathy (distress) prediction. In Table 1, Male, Female, and Allₛ denote the respective data subsets. Allₛ is a sampled dataset with an approximately equal number of samples from the Male and Female subsets, and hence is comparable in size. The PT configuration involved pre-training of the BERT encoder using demography-specific training sets (e.g., a first training set having text authored by females and a second training set having text authored by males). The tBERT configuration involved training tBERT on generic data and demographic-specific portions only.

On the M and F test sets, models trained on the same demographic subset (M or F) outperformed those trained on the opposite subset or As. The accuracies of plain BERT were 48.37, 49.49, and 50.42 on the As, M, and F test sets respectively for empathy prediction. The tBERT implementation outperformed other variants. The results indicated that empathy is dependent on and influenced by the gender associated with the author.

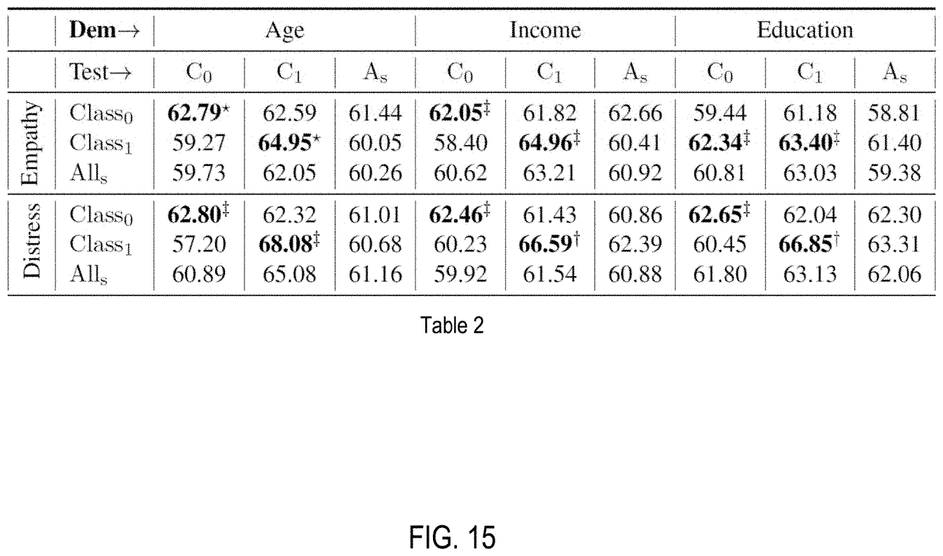

The experimentation indicated similar patterns for age, income, and education, as indicated in Table 2 depicted in FIG. 15. In Table 2, demographic-specific training accuracies for empathy (distress) prediction for age (Class₀: ≤35, Class₁: >35), income (Class₀: ≤$50,000, Class₁: >$50,000) and education (Class₀: no degree, Class₁: bachelor's or above).

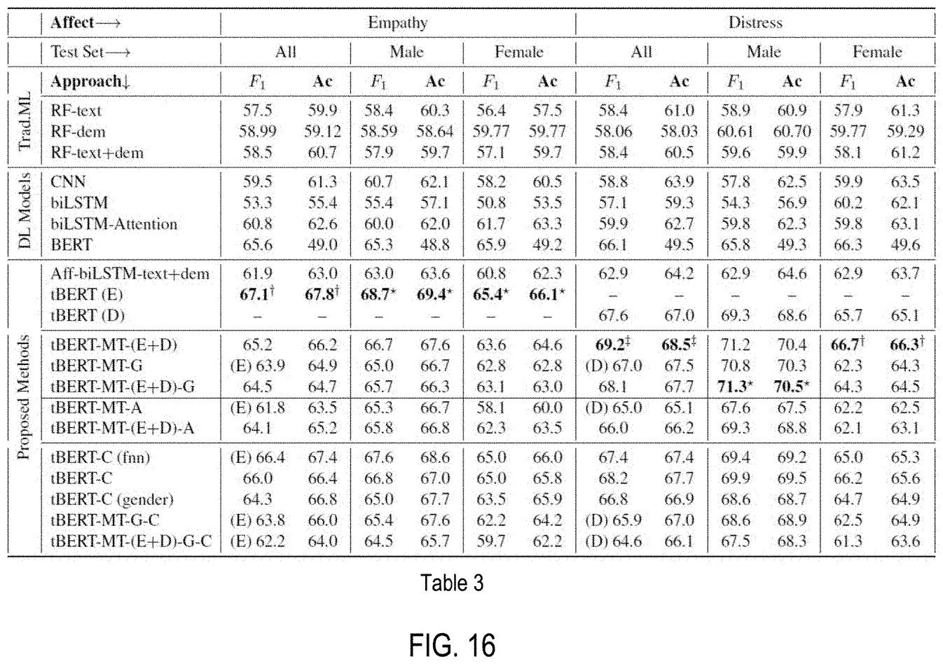

In FIG. 16, Table 3 shows results for empathy (distress) prediction using tBERT-[MT]-[C (fnn/attribute)] variants trained on the full dataset. Other configurations used in the experimentation and identified in Table 3 include tBERT-MT, in which the tBERT configuration is fine-tuned in a multitask learning (“MTL”) setup for text classification, tBERT-[MT]-C, where \vec{d} is a d-dimensional one-hot encoding vector in which d is the number of demographics, and tBERT-[MT]-C(fnn), where \vec{d} is an output of a feedforward neural network. For tBERT-MT, Table 3 specifies multitask attributes in the method name (e.g., gender (−G), age (−A) along with empathy (E) or distress (D)) alongside the accuracies. The experimentation's reports included performances on demographic-wise test sets (A, M, F). The tBERT variants with a single training objective outperformed other baselines. Furthermore, the performance of tBERT-MT varied with the affect dimension. Empathy prediction showed marginal loss in performance with explicit concatenation (tBERT-C) and further loss in the multitask setup. Also, for distress, introduction of gender as the demographic attribute showed an observable improvement across different test sets, with a similar trend observed for age

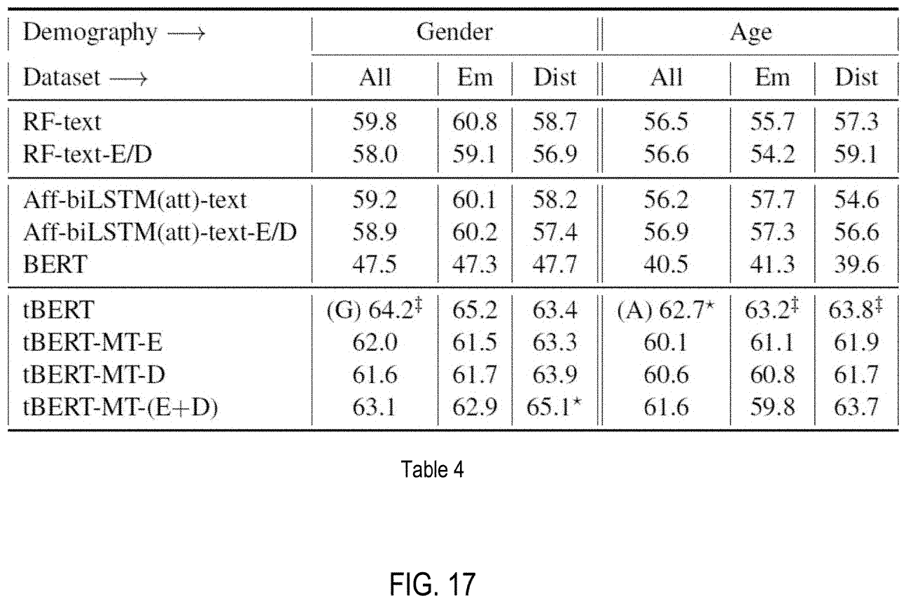

In FIG. 17, Table 4 shows performance of age and gender prediction with empathy (distress)-aware models on affect-wise test sets (Empathy (“Em”) and Distress (“Dist”)). Empathy-aware gender prediction models showed consistent improvement over baselines, with tBERT (G) reporting the best performance when tested on the complete dataset and empathy-specific test set. tBERT (A) helped improve the accuracies for age prediction by at least 5% over baselines for the complete (All) test set. For the empathy-specific test set, best results were observed with MTL (tBERT-MT-(E+D)).

The experimentation indicated that, while having affect-aware demographic prediction models does improve performance over fine-tuned models, they may also lead to a marginally negative impact. The aggregate inference from above experiments is that demographic-aware models aid affect predictions but the reverse relationship is weaker. In the experimentation, end-to-end training across a variety of test sets and demographic attributes establishes that the variance observed in language preferences and expressions has an impact on the manner of expressing these in as reactions.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method that includes performing, with one or more processing devices, operations comprising:
providing input text to a machine-learning model having (a) a BERT encoder and (b) a classification module that is trained to predict demographically specific emotional responses;
encoding, with the BERT encoder, the input text into an input text vector;
generating an emotional response score for a reader by applying the classification module to the input text vector and an input demographics vector, wherein the input demographics vector represents a demographic profile of the reader; and
outputting the emotional response score.

2. The method of claim 1, the operations further comprising generating a combined input vector by concatenating, with a neural network of the machine-learning model, the input demographics vector with the input text vector outputted by the BERT encoder,
wherein applying the classification module to the input text vector and the input demographics vector comprises:
providing the combined input vector to as an input to a dense layer set in the classification module; and
computing the emotional response score with a softmax layer connected to an output of the dense layer set.

3. The method of claim 2, wherein:
the emotional response score comprises an empathy response score and a distress response score;
the dense layer set and the softmax layer are trained to compute the empathy response score,
applying the classification module to the input text vector and the input demographics vector further comprises:
providing the combined input vector to as an additional input to an additional dense layer set in the classification module, and
computing, with an additional softmax layer connected to an output of the additional dense layer set, the distress response score.

4. The method of claim 3, the operations further comprising generating the input demographics vector by, at least, applying an additional neural network to a demographic input dataset specifying the demographic profile of the reader.

5. The method of claim 2, the operations further comprising generating the input demographics vector by, at least, applying an additional neural network to a demographic input dataset specifying the demographic profile of the reader.

6. The method of claim 1, wherein the machine-learning model is trained by:
performing, in a pre-training phase:
first iterations that modify parameters of the BERT encoder based on first input text having a first value of a demographic attribute for one or more authors of the first input text, and
second iterations that modify parameters of the BERT encoder based on second input text having a second value of the demographic attribute for one or more authors of the second input text, wherein the first and second values are different; and
performing, in a subsequent training phase, third iterations that modify parameters of a classification head in the classification module based on training input text vectors and training input demographics vectors.

7. The method of claim 6, further comprising, in the subsequent training phase:
computing loss values for the third iterations, respectively, wherein the loss values are computed by applying a binary cross entropy loss function to (a) a set of ground truth outputs respectively corresponding to the training input text vectors and the training input demographics vectors and (b) training emotional response scores respectively generated by applying the BERT encoder and the classification head to the training input text vectors and the training input demographics vectors;
identifying a first parameter value set for the BERT encoder and a second parameter value set for the classification head that were used to compute a first one of the loss values that is less than a second one of the loss values;
outputting the machine-learning model having the identified first parameter value set for the BERT encoder and the identified second parameter value set for the classification head.

8. The method of claim 1, wherein:
the machine-learning model is accessible to a text-editing tool having an editing interface,
the operations further comprise detecting, in an input field of the editing interface, the input text,
the input text is provided to the machine-learning model based on the input text being detected in the input field, and
outputting the emotional response score comprises updating the editing interface to include the emotional response score adjacent to the input field.

9. The method of claim 8, further comprising:
detecting, in the input field of the editing interface, a modification to the input text; and
responsive to detecting the modification:
applying the machine-learning model to the input text having the modification, and
updating the editing interface to include, adjacent to the input field, an updated emotional response score computed by applying the machine-learning model to the input text having the modification.

10. A method that includes performing, with one or more processing devices, operations comprising:
accessing (a) a machine-learning model having a BERT encoder and a classification head, (b) first input text having a first value of a demographic attribute for one or more authors of the first input text, and (c) second input text having a second value of the demographic attribute for one or more authors of the second input text;
performing a training process comprising:
first iterations that modify parameters of the BERT encoder based on the first input text,
second iterations that modify parameters of the BERT encoder based on the second input text, and
third iterations that modify parameters of the classification head based on training input text vectors and training input demographics vectors;
selecting a first parameter value set for the BERT encoder and a second parameter value set for the classification head, wherein the first parameter value set and the second parameter value set are computed with the training process; and
outputting the machine-learning model having the first parameter value set and the second parameter value set.

11. The method of claim 10, the operations further comprising:
computing loss values for iterations of the training process, respectively, wherein the loss values are computed by applying a binary cross entropy loss function to (a) a set of ground truth outputs respectively corresponding to the training input text vectors and the training input demographics vectors and (b) training emotional response scores respectively generated by applying the BERT encoder and the classification head to the training input text vectors and the training input demographics vectors;
identifying the first parameter value set and the second parameter value set that were used to compute a first one of the loss values; and
selecting the first parameter value set and the second parameter value set based on the first one of the loss values being less than a second one of the loss values.

12. The method of claim 11, wherein the training emotional response scores comprise training empathy response scores, wherein the operations further comprise:
modifying, in the training process, parameters of an additional classification head based on the training input text vectors and the training input demographics vectors;
computing additional loss values for the training process, wherein the additional loss values are computed by applying the binary cross entropy loss function to (a) a set of additional ground truth outputs representing distress and respectively corresponding to the training input text vectors and the training input demographics vectors and (b) training distress response scores respectively generated by applying the BERT encoder and the additional classification head to the training input text vectors and the training input demographics vectors;
identifying a third parameter value set for the additional classification head that was used, with the first parameter value set and the second parameter value set, to compute the first one of the loss values; and
selecting the third parameter value set based on the first one of the loss values being less than one or more of the additional loss values.

13. The method of claim 12, wherein applying the binary cross entropy loss function comprises a step for computing a multi-task loss for the machine-learning model.

14. The method of claim 10, further comprising:
providing input text to the machine-learning model;
encoding, with the BERT encoder, the input text into an input text vector;
generating an emotional response score for a reader by applying the classification head to the input text vector and an input demographics vector, wherein the input demographics vector represents a demographic profile of the reader; and
outputting the emotional response score.

15. A non-transitory computer-readable medium have program code stored thereon that is executable by processing hardware to perform operations comprising:
accessing input text;
a step for computing, with a BERT-based machine-learning model, a demographically-specific emotional response score from the input text; and
outputting the demographically-specific emotional response score.

16. The non-transitory computer-readable medium of claim 15, wherein the step for computing the demographically-specific emotional response score comprises:
encoding, with a BERT encoder of the BERT-based machine-learning model, the input text into an input text vector;
generating a combined input vector by, at least, concatenating, with a neural network of the BERT-based machine-learning model, an input demographics vector with the input text vector outputted by the BERT encoder, wherein the input demographics vector represents a demographic profile of a reader;
providing the combined input vector to as an input to a dense layer set in a classification head of the BERT-based machine-learning model; and
computing the demographically-specific emotional response score with a softmax layer connected to an output of the dense layer set.

17. The non-transitory computer-readable medium of claim 16, wherein:
the demographically-specific emotional response score comprises an empathy response score and a distress response score;
the dense layer set and the softmax layer are trained to compute the empathy response score,
the step for computing the demographically-specific emotional response score further comprises:
providing the combined input vector to as an additional input to an additional dense layer set in an additional classification head, and
computing, with an additional softmax layer connected to an output of the additional dense layer set, the distress response score.

18. The non-transitory computer-readable medium of claim 15, the BERT-based machine-learning model includes a BERT encoder and a classification head, wherein the operations further comprise:
performing, in a pre-training phase:
first iterations that modify parameters of the BERT encoder based on first input text having a first value of a demographic attribute for one or more authors of the first input text, and
second iterations that modify parameters of the BERT encoder based on second input text having a second value of the demographic attribute for one or more authors of the second input text, wherein the first and second values are different; and
performing, in a subsequent training phase, third iterations that modify parameters of the classification head based on training input text vectors and training input demographics vectors.

19. The non-transitory computer-readable medium of claim 15, the operations further comprising:
detecting the input text, in an input field of an editing interface of a text editing tool;
providing the input text to the BERT-based machine-learning model based on the input text being detected in the input field; and
updating the editing interface to include the demographically-specific emotional response score adjacent to the input field.

20. The non-transitory computer-readable medium of claim 19, the operations further comprising:
detecting, in the input field of the editing interface, a modification to the input text; and
responsive to detecting the modification:
applying the BERT-based machine-learning model to the input text having the modification, and
updating the editing interface to include, adjacent to the input field, an updated emotional response score computed by applying the BERT-based machine-learning model to the input text having the modification.
